(19) United States
(12) Patent Application Publication
(10) Pub. No.: US 2024/0291557 A1
(43) Pub. Date: Aug. 29, 2024

(54) SATELLITE COMMUNICATION METHOD AND APPARATUS

(71) Applicant: HUAWEI TECHNOLOGIES CO., LTD., Shenzhen (CN)

(72) Inventors: Ying CHEN, Hangzhou (CN); Feiran ZHAO, Hangzhou (CN); Ruonan YANG, Hangzhou (CN); Jun WANG, Hangzhou (CN); Jianwei ZHOU, Hangzhou (CN)

(21) Appl. No.: 18/649,666

(22) Filed: Apr. 29, 2024

Related U.S. Application Data
(63) Continuation of application No. PCT/CN2022/124891, filed on Oct. 12, 2022.

(30) Foreign Application Priority Data
Oct. 29, 2021 (CN) 202111277428.7

(51) Int. Cl. H04B 7/185

(52) U.S. Cl. CPC H04B 7/18539; H04B 7/1855; H04B 7/18589

(57) ABSTRACT

A terminal device receives first information, where the first information is for determining first duration, the first duration indicates duration from a moment at which a first beam stops a service to a moment from which a second beam provides a service, and the first beam and the second beam are beams on satellites. The terminal device communicates with a network device by using the second beam based on the first duration.

### CROSS-REFERENCE TO RELATED APPLICATIONS

This application is a continuation of International Application No. PCT/CN2022/124891, filed on Oct. 12, 2022, which claims priority to Chinese Patent Application No. 202111277428.7, filed on Oct. 29, 2021. The disclosures of the aforementioned applications are hereby incorporated by reference in their entireties.

### TECHNICAL FIELD

This application relates to the communications field, and more specifically, to a satellite communication method and apparatus.

### BACKGROUND

Compared with terrestrial communication, satellite communication has unique advantages. For example, wider coverage can be provided, a satellite base station is not vulnerable to external damage caused by a natural disaster, more data transmission resources are provided for 5^{th} generation (5G) communication, a higher-quality communication service is provided, and a network rate can be improved. Therefore, supporting both the terrestrial communication and the satellite communication is an inevitable trend of the future 5G communication, and has great benefits in wide coverage, reliability, multi-connectivity, and a high throughput.

Currently, the satellite communication has been discussed as one of application scenarios of the 5G communication in the 3^{rd} generation partnership project (3GPP). However, the current discussion and technical enhancement are mainly aimed at resolving a problem of a long transmission distance. In future satellite communication, a communication service with global coverage needs to be provided. Because a satellite-borne processing capability of a satellite is limited, and a quantity of communication beams that can be simultaneously provided is limited, a communication service cannot be simultaneously provided for a target area, or a communication service cannot be simultaneously provided globally.

Therefore, a satellite communication method is urgently needed to provide a larger-range communication service.

### SUMMARY

This application provides a satellite communication method and apparatus, to help provide a larger-range communication service, reduce complexity of a terminal device, and improve user experience.

According to a first aspect, a satellite communication method is provided, and includes: A terminal device receives first information, where the first information is for determining first duration, the first duration indicates duration from a moment at which a first beam stops a service to a moment from which a second beam provides a service, and the first beam and the second beam are beams on satellites. The terminal device communicates with a network device by using the second beam based on the first duration.

According to the technical solution in this application, the first information is sent to the terminal device, so that the terminal device can determine, based on the first information, the duration from the moment at which the first beam stops the service to the moment from which the second beam provides the service, and communicate with the network device by using the second beam on the satellite. This helps provide a larger-range communication service, reduce complexity of the terminal device, and improve user experience.

With reference to the first aspect, in some implementations of the first aspect, the first information includes a first timer, and the first timer indicates the first duration.

With reference to the first aspect, in some other implementations of the first aspect, the first information includes a second timer and a third timer, the second timer indicates duration for which the first beam provides the service, the third timer indicates duration of a periodicity of the first beam, and the method further includes: The terminal device determines the first duration based on the duration for which the first beam provides the service and the duration of the periodicity of the first beam.

With reference to the first aspect, in some implementations of the first aspect, the method further includes: The terminal device skips detecting scheduling information from the network device within timerof the first duration.

According to the technical solution in this application, the first information is sent to the terminal device, so that the terminal device can determine, based on the first information, the duration from the moment at which the first beam stops the service to the moment from which the second beam provides the service. In this way, the terminal device can skip detecting the scheduling information within the timer of the duration, thereby entering a power saving mode. This helps reduce the complexity and power consumption of the terminal.

With reference to the first aspect, in some implementations of the first aspect, the network device is located on the satellite. The method further includes: The terminal device receives global navigation satellite system GNSS positioning information and ephemeris information of the second beam, where the ephemeris information of the second beam indicates ephemeris information corresponding to a case in which the second beam provides the service for the terminal device. The terminal device synchronizes with the network device based on the GNSS positioning information and the ephemeris information.

With reference to the first aspect, in some other implementations of the first aspect, the network device is located on a terrene. The method further includes: The terminal device receives global navigation satellite system GNSS positioning information, ephemeris information of the second beam, and common timing advance information, where the ephemeris information of the second beam indicates ephemeris information corresponding to a case in which the second beam provides the service for the terminal device. The terminal device synchronizes with the network device based on the GNSS positioning information, the ephemeris information, and the common timing advance information.

With reference to the first aspect, in some implementations of the first aspect, the method further includes: The terminal device receives scheduling information corresponding to the second beam.

With reference to the first aspect, in some implementations of the first aspect, the first beam corresponds to a first bandwidth configuration, the second beam corresponds to a second bandwidth configuration, and the first bandwidth configuration is the same as the second bandwidth configuration.

With reference to the first aspect, in some implementations of the first aspect, the first beam corresponds to a first bandwidth configuration, the second beam corresponds to a second bandwidth configuration, and the first bandwidth configuration is different from the second bandwidth configuration.

With reference to the first aspect, in some implementations of the first aspect, the method further includes: The terminal device obtains a first periodicity, where the first periodicity indicates a periodicity of the first duration. That the terminal device communicates with a network device by using the second beam based on the first duration includes: The terminal device communicates with the network device by using the second beam based on the first duration and the first periodicity.

According to the technical solution in this application, the terminal device obtains periodicity information of the first duration, so that the first timer can work for a period of time. In this way, signaling overheads are reduced, and configuration flexibility is improved.

With reference to the first aspect, in some implementations of the first aspect, the method further includes: The terminal device receives control information. The terminal device activates the first timer based on the control information; or the terminal device activates the second timer and the third timer based on the control information.

According to a second aspect, a satellite communication method is provided, and includes: A network device determines first information, where the first information is used by a terminal device to determine first duration, the first duration indicates duration from a moment at which a first beam stops a service to a moment from which a second beam provides a service, and the first beam and the second beam are beams on satellites. The network device sends the first information to the terminal device.

According to the technical solution in this application, the first information is sent to the terminal device, so that the terminal device can determine, based on the first information, the duration from the moment at which the first beam stops the service to the moment from which the second beam provides the service, and communicate with the network device by using the second beam on the satellite. This helps provide a larger-range communication service, reduce complexity of the terminal device, and improve user experience.

With reference to the second aspect, in some implementations of the second aspect, the first information includes a first timer, and the first timer indicates the first duration.

With reference to the second aspect, in some other implementations of the second aspect, the first information includes a second timer and a third timer, the second timer indicates duration for which the first beam provides the service, and the third timer indicates duration of a periodicity of the first beam.

With reference to the second aspect, in some implementations of the second aspect, the method further includes: The network device skips sending scheduling information to the terminal device within timer of the first duration.

According to the technical solution in this application, the first information is sent to the terminal device, so that the terminal device can determine, based on the first information, the duration from the moment at which the first beam stops the service to the moment from which the second beam provides the service. In this way, the terminal device can skip detecting the scheduling information within the duration of the timer, thereby entering a power saving mode. This helps reduce the complexity and power consumption of the terminal.

With reference to the second aspect, in some implementations of the second aspect, the network device is located on the satellite. The method further includes: The network device sends global navigation satellite system GNSS positioning information and ephemeris information of the second beam, where the ephemeris information of the second beam indicates ephemeris information corresponding to a case in which the second beam provides the service for the terminal device, and the GNSS positioning information and the ephemeris information are used by the terminal device to synchronize with the network device.

With reference to the second aspect, in some other implementations of the second aspect, the network device is located on a terrene. The method further includes: The network device sends global navigation satellite system GNSS positioning information, ephemeris information of the second beam, and common timing advance information, where the ephemeris information of the second beam indicates ephemeris information corresponding to a case in which the second beam provides the service for the terminal device, and the GNSS positioning information, the ephemeris information, and the common timing advance information are used by the terminal device to synchronize with the network device.

With reference to the second aspect, in some implementations of the second aspect, the method further includes: The terminal device receives scheduling information corresponding to the second beam.

With reference to the second aspect, in some implementations of the second aspect, the first beam corresponds to a first bandwidth configuration, the second beam corresponds to a second bandwidth configuration, and the first bandwidth configuration is the same as the second bandwidth configuration.

With reference to the second aspect, in some implementations of the second aspect, the first beam corresponds to a first bandwidth configuration, the second beam corresponds to a second bandwidth configuration, and the first bandwidth configuration is different from the second bandwidth configuration.

With reference to the second aspect, in some implementations of the second aspect, the method further includes: The network device sends a first periodicity, where the first periodicity indicates a periodicity of the first duration.

With reference to the second aspect, in some implementations of the second aspect, the method further includes: The network device sends control information, where the control information is for activating the first timer; or the control information is for activating the second timer and the third timer.

According to a third aspect, a satellite communication apparatus is provided, and includes: a transceiver unit, configured to receive first information, where the first information is for determining first duration, the first duration indicates duration from a moment at which a first beam stops a service to a moment from which a second beam provides a service, and the first beam and the second beam are beams on satellites; and a processing unit, configured to communicate with a network device by using the second beam based on the first duration.

With reference to the third aspect, in some implementations of the third aspect, the first information includes a first timer, and the first timer indicates the first duration.

With reference to the third aspect, in some implementations of the third aspect, the first information includes a second timer and a third timer, the second timer indicates duration for which the first beam provides the service, the third timer indicates duration of a periodicity of the first beam, and the processing unit is specifically configured to determine the first duration based on the duration for which the first beam provides the service and the duration of the periodicity of the first beam.

With reference to the third aspect, in some implementations of the third aspect, the processing unit is further configured to skip detecting scheduling information from the network device within timer of the first duration.

With reference to the third aspect, in some implementations of the third aspect, the network device is located on the satellite. The transceiver unit is further configured to receive global navigation satellite system GNSS positioning information and ephemeris information of the second beam, where the ephemeris information of the second beam indicates ephemeris information corresponding to a case in which the second beam provides the service for the satellite communication apparatus. The processing unit is further configured to synchronize with the network device based on the GNSS positioning information and the ephemeris information.

With reference to the third aspect, in some other implementations of the third aspect, the network device is located on a terrene. The transceiver unit is further configured to receive global navigation satellite system GNSS positioning information, ephemeris information of the second beam, and common timing advance information, where the ephemeris information of the second beam indicates ephemeris information corresponding to a case in which the second beam provides the service for the satellite communication apparatus. The processing unit is further configured to synchronize with the network device based on the GNSS positioning information, the ephemeris information, and the common timing advance information.

With reference to the third aspect, in some implementations of the third aspect, the transceiver unit is further configured to receive scheduling information corresponding to the second beam.

With reference to the third aspect, in some implementations of the third aspect, the first beam corresponds to a first bandwidth configuration, the second beam corresponds to a second bandwidth configuration, and the first bandwidth configuration is the same as the second bandwidth configuration.

With reference to the third aspect, in some implementations of the third aspect, the first beam corresponds to a first bandwidth configuration, the second beam corresponds to a second bandwidth configuration, and the first bandwidth configuration is different from the second bandwidth configuration.

With reference to the third aspect, in some implementations of the third aspect, the transceiver unit is further configured to obtain a first periodicity, where the first periodicity indicates a periodicity of the first duration. The processing unit is specifically used by the satellite communication apparatus to communicate with the network device by using the second beam based on the first duration and the first periodicity.

With reference to the third aspect, in some implementations of the third aspect, the transceiver unit is further configured to receive control information. The processing unit is further configured to activate the first timer based on the control information; or the processing unit is further configured to activate the second timer and the third timer based on the control information.

According to a fourth aspect, a satellite communication apparatus is provided, and includes: a processing unit, configured to determine first information, where the first information is used by a terminal device to determine first duration, the first duration indicates duration from a moment at which a first beam stops a service to a moment from which a second beam provides a service, and the first beam and the second beam are beams on satellites; and a transceiver unit, configured to send the first information to the terminal device.

With reference to the fourth aspect, in some implementations of the fourth aspect, the first information includes a first timer, and the first timer indicates the first duration.

With reference to the fourth aspect, in some other implementations of the fourth aspect, the first information includes a second timer and a third timer, the second timer indicates duration for which the first beam provides the service, and the third timer indicates duration of a periodicity of the first beam.

With reference to the fourth aspect, in some implementations of the fourth aspect, the transceiver unit is further configured to skip sending scheduling information to the terminal device within timer of the first duration.

With reference to the fourth aspect, in some implementations of the fourth aspect, the satellite communication apparatus is located on the satellite. The transceiver unit is further configured to send global navigation satellite system GNSS positioning information and ephemeris information of the second beam, where the ephemeris information of the second beam indicates ephemeris information corresponding to a case in which the second beam provides the service for the terminal device, and the GNSS positioning information and the ephemeris information are used by the terminal device to synchronize with the satellite communication apparatus.

With reference to the fourth aspect, in some other implementations of the fourth aspect, the satellite communication apparatus is located on a terrene. The transceiver unit is further configured to send global navigation satellite system GNSS positioning information, ephemeris information of the second beam, and common timing advance information, where the ephemeris information of the second beam indicates ephemeris information corresponding to a case in which the second beam provides the service for the terminal device, and the GNSS positioning information, the ephemeris information, and the common timing advance information are used by the terminal device to synchronize with the satellite communication apparatus.

With reference to the fourth aspect, in some implementations of the fourth aspect, the transceiver unit is further configured to receive scheduling information corresponding to the second beam.

With reference to the fourth aspect, in some implementations of the fourth aspect, the first beam corresponds to a first bandwidth configuration, the second beam corresponds to a second bandwidth configuration, and the first bandwidth configuration is the same as the second bandwidth configuration.

With reference to the fourth aspect, in some implementations of the fourth aspect, the first beam corresponds to a first bandwidth configuration, the second beam corresponds to a second bandwidth configuration, and the first bandwidth configuration is different from the second bandwidth configuration.

With reference to the fourth aspect, in some implementations of the fourth aspect, the transceiver unit is further configured to send a first periodicity, where the first periodicity indicates a periodicity of the first duration.

With reference to the fourth aspect, in some implementations of the fourth aspect, the transceiver unit is further used by the satellite communication apparatus to send control information, where the control information is for activating the first timer; or the control information is for activating the second timer and the third timer.

According to a fifth aspect, a communication apparatus is provided, and includes a processor. The processor is coupled to a memory. The memory is configured to store a program or instructions. When the program or the instructions are executed by the processor, the apparatus is enabled to implement the method in any one of the first aspect or the second aspect and the implementations of the first aspect or the second aspect.

Optionally, there are one or more processors, and there are one or more memories.

Optionally, the memory may be integrated with the processor, or the memory may be disposed separately from the processor.

According to a sixth aspect, a communication system is provided, and includes a terminal device and a network device.

The terminal device is configured to implement the method in the implementations of the first aspect, and the network device is configured to implement the method in the implementations of the second aspect.

In a possible design, the communication system further includes another device that interacts with a communication device in the solution provided in embodiments of this application.

According to a seventh aspect, a computer program product is provided. The computer program product includes computer program code. When the computer program code is run on a computer, the computer is enabled to perform the methods in the foregoing aspects.

It should be noted that all or some of computer program code may be stored in a first storage medium. The first storage medium may be encapsulated together with a processor, or may be encapsulated separately from a processor. This is not specifically limited in this embodiment of this application.

According to an eighth aspect, a computer-readable medium is provided. The computer-readable medium stores program code. When the computer program code is run on a computer, the computer is enabled to perform the methods in the foregoing aspects.

According to a ninth aspect, a chip system is provided, and includes a memory and a processor. The memory is configured to store a computer program. The processor is configured to invoke the computer program from the memory and run the computer program, to enable a communication device on which the chip system is installed to perform the method in any one of the first aspect to the fifth aspect and the implementations of the first aspect to the fifth aspect.

The chip system may include an output chip or interface configured to send information or data, and an input chip or interface configured to receive information or data.

### BRIEF DESCRIPTION OF DRAWINGS

FIG. 1 is a schematic diagram of a multi-beam satellite communication system according to an embodiment of this application;

FIG. 2 shows an application scenario of a satellite network according to an embodiment of this application;

FIG. 3 is a schematic diagram of providing a plurality of beams by one satellite according to an embodiment of this application;

FIG. 4 is a schematic diagram of a satellite communication method according to this application;

FIG. 5 is a schematic diagram of a specific example of a satellite communication method according to this application;

FIG. 6 is a schematic diagram of being served by beams in different frequency bands at different moments in a same beam position or beam direction according to this application;

FIG. 7 is a schematic diagram of a timer configuration manner according to this application;

FIG. 8 is a schematic diagram of being served by beams in different frequency bands at a same moment in a same beam position or beam direction according to this application;

FIG. 9 is another schematic diagram of a timer configuration manner according to this application;

FIG. 10 is a schematic diagram of collaboration service performed by a plurality of beams on a plurality of satellites according to this application;

FIG. 11 is another schematic diagram of a specific example of a satellite communication method according to this application;

FIG. 12 is still another schematic diagram of a timer configuration manner according to this application;

FIG. 13 is a schematic diagram of a structure of a satellite communication device according to this application; and

FIG. 14 is a schematic diagram of a structure of a satellite communication apparatus according to this application.

### DESCRIPTION OF EMBODIMENTS

The following describes technical solutions in this application with reference to accompanying drawings.

The technical solutions in this application may be applied to non-terrestrial network (NTN) systems such as a satellite communication system, high altitude platform station (HAPS) communication, air-to-ground (A2G) communication, and an uncrewed aerial vehicle (OVA). For example, the technical solutions may be applied to an integrated communication and navigation (Incan) system and a global navigation satellite system (GNSS).

The satellite communication system may be integrated with a conventional mobile communication system. For example, the mobile communication system may be a 4th generation (4G) communication system (for example, a long term evolution (LTE) system), a worldwide interoperability for microwave access (WiMAX) communication system, a 5th generation (5G) communication system (for example, a new radio (NR) system), and a future mobile communication system.

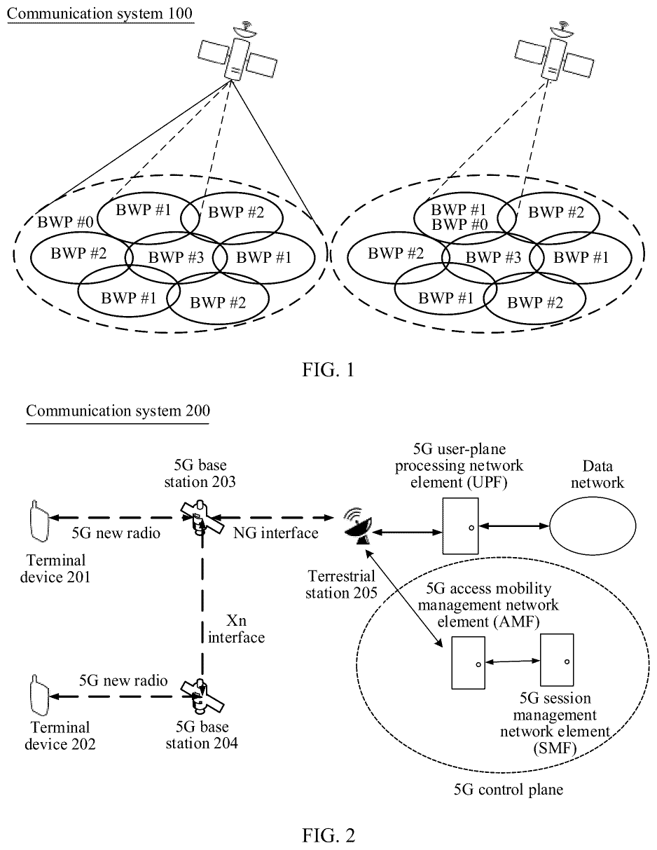

FIG. 1 is a schematic diagram of a multi-beam satellite communication system according to an embodiment of this application.

As shown in FIG. 1, beams on a satellite are classified into a traffic beam and a broadcast beam. In an ideal case in which satellite-borne processing complexity is not considered, it may be assumed that the satellite can simultaneously provide a large quantity of beams, and the traffic beam can cover all target service areas. In addition, the broadcast beam carries some cell-level system messages for a terminal device to perform random access, and initial access of the terminal device may be completed on the broadcast beam. The broadcast beam may be used as a wide beam to cover all traffic beams in a cell, or may be used as a narrow beam to cover different data beams in different time periods successively through periodic sweeping. To avoid inter-beam interference, different frequency bands may be used for adjacent traffic beams and for the traffic beam and the broadcast beam, and are usually referred to as bandwidth parts (BWPs).

However, in an actual application scenario, because energy that can be provided on the satellite is limited, when the broadcast beam is the wide beam, the energy cannot be concentrated. Consequently, a signal received by the terminal device is weak, and finally decoding of the broadcast signal fails. In addition, for the traffic beam, a quantity of beams that can be provided by the satellite is also limited. Because a coverage area of the satellite is large, the traffic beam that may be provided cannot simultaneously cover all areas.

In a satellite communication system discussed in an existing standard, a traffic beam in the satellite communication system temporarily does not support a beam hopping technology. When a satellite-borne processing capability is limited, a larger-range communication service cannot be provided, and finally global coverage cannot be implemented.

Based on this, in this application, for a satellite communication scenario, a target area is divided into a plurality of beam positions or beam directions. A beam hopping manner is used. To be specific, beams on a satellite provide communication services for terminal devices in different beam positions or beam directions at different moments. This can implement full coverage of the target area, and helps reduce complexity of the terminal device and improve user experience.

For ease of understanding embodiments of this application, concepts in embodiments are first described below.

### 1. Satellite Communication

A satellite communication system consists of three parts: a satellite end, a terrestrial end, and a user end. In a previous satellite communication system, a satellite end functions as a relay station in the air. To be specific, the satellite end amplifies an electromagnetic wave that is sent by a terrestrial station, and then returns an amplified electromagnetic wave to another terrestrial station. A satellite body includes two subsystems: a satellite-borne device and a satellite. The terrestrial station is an interface between the satellite system and a terrestrial public network. A terrestrial user may also enter and exit from the satellite system through the terrestrial station to form a link. The terrestrial station further includes a terrestrial satellite control center and a tracking, telemetry, and command station. The user end is various user terminal devices.

An application field of the satellite communication constantly expands. In addition to departments such as finance, securities, posts and telecommunication, meteorology, and an earthquake, remote education, telemedicine, emergency relief, emergency communication, emergency television broadcasting, sea, land, and air navigation, an internet-connected network phone and television, and the like will be widely used.

To implement more flexible networking, there is a trend towards using of a cellular technology for the satellite communication. For example, a base station (BS) is moved to the satellite.

### 2. Beamforming

To reduce a propagation loss of a radio wave and increase a transmission distance thereof, antenna technologies such as the beamforming, massive multiple-input multiple-output (MIMO), full-dimension MIMO (FD-MIMO), an array antenna, digital beamforming, and analog beamforming (analog beamforming) are discussed in a 5G system.

A network device (for example, a gNB or a TRP) in the 5G system may interact with user equipment by using the beamforming technology. The network device may usually form a plurality of downlink (DL) transmit beams (Tx beams), and send, on one or more DL Tx beams, a downlink signal to a terminal device within coverage of the beam. The terminal device may receive the downlink signal by using a receive beam (Rx beam) or an omnidirectional antenna, to obtain a large array gain. A higher data transmission rate is implemented between the network device and the user equipment by using the beamforming technology.

### 3. Synchronization

In satellite communication, a terminal device needs to first implement time synchronization with a network device. In a case of the synchronization, the network device and the terminal device may obtain, through parsing according to a pre-agreed protocol, specific content included in a signal. The terminal device first needs to detect a primary synchronization signal. NR is used as an example. In a synchronization process, the network device first sends a synchronization signal block (SSB) beam, and the terminal device performs sweeping by using a wide beam. After both the UE and the BS perform sweeping, a narrow-beam range of the network device and a wide-beam range of the terminal device are determined. For example, in an NR system, a repetition periodicity of an SSB may be 5 ms, and each periodicity includes one SSB. Therefore, the terminal device may obtain 5 ms timing of a cell by capturing the primary synchronization signal (PSS).

### 4. Random Access (RA)

The random access is an information exchange mechanism (or process) for establishing, in an LTE or 5G communication system with access control, a connection between a network and a device that has not accessed the network. Because a random access process is carried by a random access channel (RACH), the RA and the RACH are also usually interchangeable in a protocol and spoken language. The random access is classified into contention-based random access and non-contention-based random access. The contention-based random access is usually divided into four steps, and each step corresponds to one message. A message 1, a message 2, a message 3, and a message 4 are included, and respectively carry different signaling or information. The non-contention-based random access includes only the first two steps. In addition, to reduce access time of the four-step contention-based random access, there is further two-step random access. The two-step random access consists of a message A and a message B. The message A includes a preamble and the first piece of data information (for example, similar to the message 1 and the message 3 in the four-step random access), and the message B includes contention resolution and uplink scheduling (for example, similar to the message 2 and the message 4 in the four-step random access).

It should be understood that the foregoing related descriptions of the satellite communication, the beamforming, the downlink synchronization, the random access, and the like are merely for ease of understanding the technical solutions in this application, but constitute no limitation on this application.

FIG. 2 shows an application scenario of a satellite network according to an embodiment of this application. A terrestrial mobile terminal accesses a network through an air interface (the air interface may be various types of air interfaces, for example, a 5G air interface). An access network device may be deployed on a satellite or a terrene, and is connected to a core network on the terrene through a radio link. In addition, there is a radio link between satellites, to implement signaling exchange and user data transmission between access network devices. Network elements in FIG. 2 and interfaces thereof are described as follows:

A terminal device includes a mobile device that supports new radio, and may access the satellite network through the air interface and initiate services such as calling and internet access.

The access network device mainly provides a radio access service, schedules a radio resource to an access terminal, provides a reliable wireless transmission protocol and data encryption protocol, and so on.

The core network provides services such as user access control, mobility management, session management, user security authentication, and charging, consists of a plurality of functional units, and may be divided into a control-plane functional entity and a data-plane functional entity. An access and mobility management unit (AMF) is responsible for user access management, the security authentication, and the mobility management. A user plane function (UPF) is responsible for managing functions such as user plane data transmission and traffic statistics collection.

A terrestrial station is responsible for forwarding signaling and service data between a satellite base station and the core network.

The air interface is a radio link between the terminal and a base station.

An Xn interface is an interface between base stations, and is mainly for signaling exchange such as handover.

An NG interface is an interface between the base station and the core network, and is mainly for exchanging signaling such as non-access stratum (NAS) signaling of the core network and service data of a user.

This application is applied to a communication system such as 5G, and relates to radio access network elements such as UE, the base station, and the terrestrial station, to perform uplink and downlink data communication based on a wireless communication protocol.

In embodiments of this application, the access network device is not limited to the satellite base station, and the access network device may be further deployed on a high-altitude platform, the satellite, the terrene, or the like.

The access network device may be an evolved NodeB (eNB or eNodeB) in LTE, or a base station in a 5G network or a future evolved public land mobile network (PLMN), a broadband network gateway (BNG), an aggregation switch, a non-3^{rd} generation partnership project (3GPP) access device, or the like. This is not specifically limited in embodiments of this application.

Optionally, the access network device in embodiments of this application may include base stations in various forms, for example, a macro base station, a micro base station (which is also referred to as a small cell), a relay station, an access point, a next-generation base station (gNodeB, gNB), a baseband unit (BBU), a transmission reception point (TRP), a transmitting point (TP), and a mobile switching center. This is not specifically limited in embodiments of this application. The satellite mentioned in embodiments of this application may alternatively be the satellite base station or a satellite-borne network-side device.

The terminal device mentioned in embodiments of this application includes various handheld devices, vehicle-mounted devices, wearable devices, computing devices, or other processing devices connected to a wireless modem that have a wireless communication function, and may be specifically the user equipment (UE), the access terminal, a subscriber unit, a subscriber station, a mobile station, a remote station, a remote terminal, a mobile device, a user terminal, a terminal, a wireless communication device, a user agent, or a user apparatus. The terminal device may alternatively be a satellite phone, a cellular phone, a smartphone, a wireless data card, a wireless modem, a machine type communication device, a cordless phone, a session initiation protocol (SIP) phone, a wireless local loop (WLL) station, a personal digital assistant (PDA), a handheld device, a computing device, another processing device connected to a wireless modem, a vehicle-mounted device, or a wearable device that has a wireless communication function, a virtual reality (VR) terminal device, an augmented reality (AR) terminal device, a wireless terminal in industrial control, a wireless terminal in self driving, a wireless terminal in telemedicine, a wireless terminal in a smart grid, a wireless terminal in transportation safety, a wireless terminal in a smart city, a wireless terminal in a smart home, a terminal device in the 5G network or a future communication network, or the like.

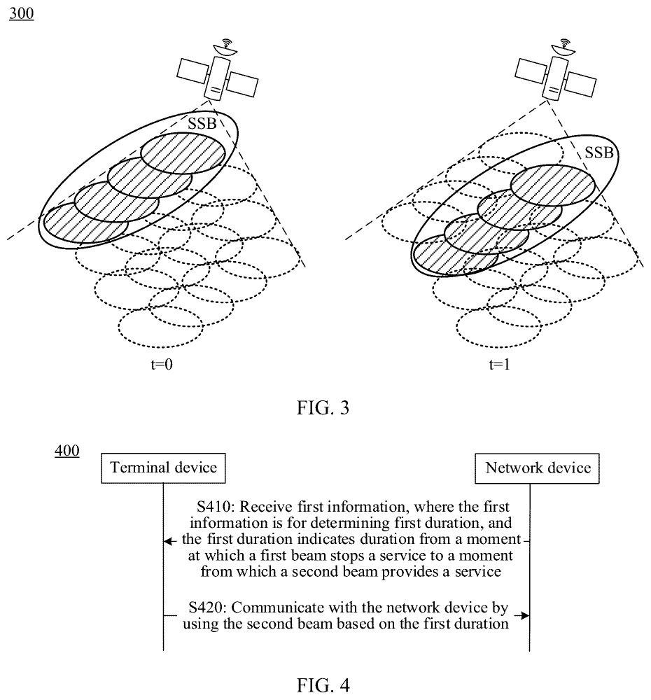

FIG. 3 is a schematic diagram of providing a plurality of beams by one satellite according to an embodiment of this application.

As shown in FIG. 3, the satellite may provide the plurality of beams including at least one broadcast beam and a plurality of traffic beams. In a possible scenario, sizes of the broadcast beam and the traffic beam are different. The plurality of traffic beams performs beam hopping together in an adjacency manner. The broadcast beam covers all traffic beams. Two types of beams hop in different beam positions or beam directions periodically or aperiodically. For example, the beams are respectively in the different beam positions or beam directions at a moment t=0 and a moment t=1.

In another possible scenario, sizes of the broadcast beam and the traffic beam are the same. In other words, in this scenario, a quantity of broadcast beams is the same as a quantity of the traffic beams, and the broadcast beams and the traffic beams perform beam hopping based on a same manner. The plurality of broadcast beams or the plurality of traffic beams are not necessarily adjacent, and may perform periodic or aperiodic beam hopping based on an actual service status.

The following describes the technical solutions in this application.

FIG. 4 is a schematic diagram of a satellite communication method according to this application.

S410: A terminal device receives first information, where the first information is for determining first duration, and the first duration indicates duration from a moment at which a first beam stops a service to a moment from which a second beam provides a service.

The first beam and the second beam are beams on satellites.

In a possible implementation, the first information includes a first timer, and the first timer indicates the first duration.

In another possible implementation, the first information includes a second timer and a third timer, the second timer indicates duration for which the first beam provides the service, the third timer indicates duration of a periodicity of the first beam, and the method further includes: The terminal device determines the first duration based on the duration for which the first beam provides the service and the duration of the periodicity of the first beam.

Optionally, the method further includes: The terminal device skips detecting scheduling information from a network device within timer of the first duration.

In this way, according to the technical solution in this application, the first information is sent to the terminal device, so that the terminal device can determine, based on the first information, the duration from the moment at which the first beam stops the service to the moment from which the second beam provides the service. In this way, the terminal device can skip detecting the scheduling information within the timer of the duration, thereby entering a power saving mode. This helps reduce complexity and power consumption of the terminal.

Optionally, the network device is located on the satellite. The method further includes: The terminal device receives global navigation satellite system GNSS positioning information and ephemeris information of the second beam, where the ephemeris information of the second beam indicates ephemeris information corresponding to a case in which the second beam provides the service for the terminal device. The terminal device synchronizes with the network device based on the GNSS positioning information and the ephemeris information.

Optionally, the network device is located on a terrene. The method further includes: The terminal device receives global navigation satellite system GNSS positioning information, ephemeris information of the second beam, and common timing advance information, where the ephemeris information of the second beam indicates ephemeris information corresponding to a case in which the second beam provides the service for the terminal device. The terminal device synchronizes with the network device based on the GNSS positioning information, the ephemeris information, and the common timing advance information.

Optionally, the method further includes: The terminal device receives scheduling information corresponding to the second beam.

Optionally, the first beam corresponds to a first bandwidth configuration, the second beam corresponds to a second bandwidth configuration, and the first bandwidth configuration is the same as the second bandwidth configuration.

Optionally, the first beam corresponds to a first bandwidth configuration, the second beam corresponds to a second bandwidth configuration, and the first bandwidth configuration is different from the second bandwidth configuration.

Optionally, the method further includes: The terminal device obtains a first periodicity, where the first periodicity indicates a periodicity of the first duration. That the terminal device communicates with the network device by using the second beam based on the first duration includes: The terminal device communicates with the network device by using the second beam based on the first duration and the first periodicity.

In this way, according to the technical solution in this application, the terminal device obtains periodicity information of the first duration, so that the first timer can work for a period of time. In this way, signaling overheads are reduced, and configuration flexibility is improved.

Optionally, the method further includes: The terminal device receives control information. The terminal device activates the first timer based on the control information; or the terminal device activates the second timer and the third timer based on the control information.

S420: The terminal device communicates with the network device by using the second beam based on the first duration.

For a communication process, refer to a conventional technology. Details are not described herein again.

According to the technical solution in this application, the first information is sent to the terminal device, so that the terminal device can determine, based on the first information, the duration from the moment at which the first beam stops the service to the moment from which the second beam provides the service, and communicate with the network device by using the second beam on the satellite. This helps provide a larger-range communication service, reduce the complexity of the terminal device, and improve user experience.

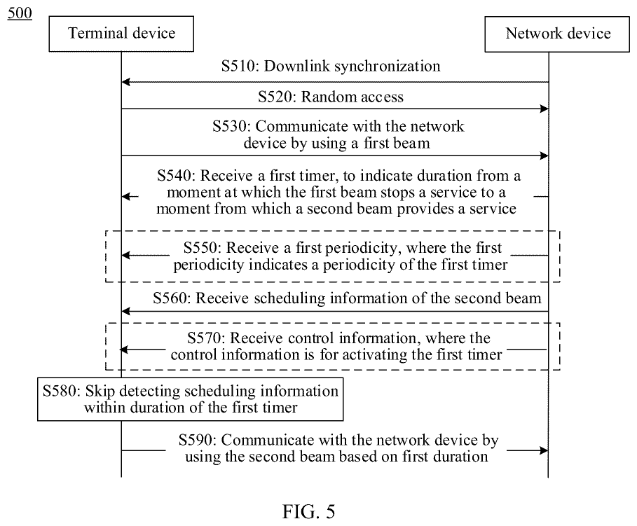

FIG. 5 is a schematic diagram of a specific example of a satellite communication method according to this application.

S510: A terminal device performs downlink synchronization with a network device.

Specifically, the terminal device may receive a broadcast message, where the broadcast message may include uplink and downlink ephemeris information, common timing advance information, scheduling information for data communication, and the like. When the terminal device sends an uplink signal, to ensure synchronization of the terminal device on a base station side, the terminal device needs to perform timing advance. For example, when the network device is on a satellite, the terminal device needs to determine a round-trip transmission delay between the terminal device and the satellite based on GNSS positioning information and the ephemeris information, to complete the timing advance. For another example, when the network device is on a terrene, the terminal device needs to determine a round-trip transmission delay between the terminal device and a satellite based on GNSS positioning information and the ephemeris information, and determine a round-trip transmission delay between the satellite and a terrestrial station based on the common timing advance information carried in the broadcast message, to complete the timing advance.

S520: The terminal device completes random access.

For a random access process, refer to the foregoing descriptions or another existing technical solution. For brevity, details are not described herein again.

S530: The terminal device communicates with the network device by using a first beam.

The first beam is a beam on the satellite, and may be a broadcast beam or a traffic beam.

S540: The terminal device receives a first timer, where the first timer indicates duration from a moment at which the first beam stops a service to a moment from which a second beam provides a service.

For ease of description, the duration from the moment at which the first beam stops the service to the moment from which the second beam provides the service may be referred to as first duration. In this embodiment, the first duration is determined by using the first timer.

The second beam is a beam on a satellite, and may be a broadcast beam or a traffic beam.

Optionally, the first beam and the second beam may be beams on a same satellite, or may be beams on different satellites. This is not limited in this application.

Optionally, a bandwidth configuration or a polarization configuration corresponding to the first beam may be the same as or different from a bandwidth configuration or a polarization configuration corresponding to the second beam. This is not limited in this application.

In this embodiment of this application, a timer may determine duration. For example, the first timer may determine the first duration, where the first duration may indicate the duration from the moment at which the first beam stops the service to the moment from which the second beam provides the service.

It should be understood that the duration may be a time unit such as a millisecond, a slot, or a symbol. This is not limited in this application.

It should be further understood that neither an expression of the duration nor an expression of the timer has additional impact on the technical solution in this application. A person skilled in the art may represent the timer by using methods such as the duration, a timing counter, and a timing identifier based on this application, and all methods shall fall within the protection scope of this application.

S550: The terminal device receives a first periodicity, where the first periodicity indicates a periodicity of the first timer.

Specifically, when the first beam performs beam hopping periodically, the first periodicity may be an agreed periodicity, or may be a periodicity determined in another manner. For example, the terminal device may obtain the first periodicity based on downlink-signal detection. That is, an interval between two detected downlink signals is the first periodicity. For another example, the terminal device may directly obtain the first periodicity based on a master information block (MIB). For still another example, the terminal device may alternatively obtain the first periodicity based on blind detection of a downlink signal (for example, a MIB, a primary synchronization signal (PSS), or a secondary synchronization signal (SSS)). That is, the first periodicity is indicated in a scrambling manner.

Optionally, the first periodicity of the first beam may alternatively one-to-one correspond to an index of the first beam. Each broadcast information block has an index corresponding thereto. The terminal may obtain an index of a broadcast signal by parsing the broadcast signal, and then determine a periodicity of the broadcast signal based on an index number. For example, an index 1 corresponds to a periodicity of 1 ms, an index 2 corresponds to a periodicity of 2 ms, and an index 3 corresponds to a periodicity of 5 ms; or 1 to 5 correspond to a periodicity of 5 ms, and 5 to 10 correspond to a periodicity of 10 ms.

The first beam may be the broadcast beam or the traffic beam.

In this way, according to the technical solution in this application, the terminal device obtains periodicity information of the timer, so that the timer can work for a period of time. In this way, signaling overheads are reduced, and configuration flexibility is improved.

S560: The terminal device receives scheduling information of the second beam.

The terminal device receives the scheduling information of the second beam, to complete the random access. For a process of the random access, refer to the foregoing descriptions or another conventional technology. For brevity, details are not described herein again. The scheduling information of the second beam may be received when the terminal uses the first beam for communication, or may be received before the second beam arrives. This is not limited in this application.

When the network device is located on the satellite, the terminal device needs to receive the global navigation satellite system GNSS positioning information and ephemeris information of the second beam, where the ephemeris information of the second beam indicates ephemeris information corresponding to a case in which the second beam provides the service for the terminal device; and the terminal device synchronizes with the network device based on the GNSS positioning information and the ephemeris information.

When the network device is located on the terrene, the terminal device needs to receive the global navigation satellite system GNSS positioning information, ephemeris information of the second beam, and the common timing advance information, where the ephemeris information of the second beam indicates ephemeris information corresponding to a case in which the second beam provides the service for the terminal device; and the terminal device synchronizes with the network device based on the GNSS positioning information, the ephemeris information, and the common timing advance information.

Optionally, the terminal device further needs to receive another type of beam information. This is not limited in this application. For example, when the second beam cannot completely overlap the first beam, the terminal device further needs to receive frequency information, center information, information about a distance from a center to a beam edge, and the like of the second beam. For another example, when the second beam indicates the terminal device to perform cell switching, the terminal device further needs to receive information including cell information and measurement information.

S570: The terminal device receives control information, where the control information is for activating the first timer.

In this embodiment of this application, the first timer may be a configured fixed value. However, in another possible implementation, during actual use, to improve configuration flexibility, a plurality of candidate values may be configured for the first timer, and one of the candidate values is activated by using the control information.

The control information may include cell-level, UE-level, and beam-level messages, and common information of some users. Specific signaling may be radio resource control (RRC), media access control (MAC) control element (CE) signaling, or downlink control information (DCI). This is not limited in this application.

After receiving the control information, the terminal device may immediately activate the first duration (that is, the first duration immediately takes effect), or may activate the first duration after a specific period of time (that is, the first duration takes effect with a delay). This is not limited in this application.

S580: The terminal device skips detecting the scheduling information within timer of the first duration.

Specifically, within the timer of the first duration, the terminal device is covered by no broadcast beam or traffic beam (that is, served by no beam), and the terminal device does not need to monitor any signal. Therefore, some power-saving modes such as discontinuous reception (DRX) may be used.

In this way, according to the technical solution in this application, first information is sent to the terminal device, so that the terminal device can determine, based on the first information, the duration from the moment at which the first beam stops the service to the moment from which the second beam provides the service. In this way, the terminal device can skip detecting the scheduling information within the timer of the duration, thereby entering the power saving mode. This helps reduce complexity and power consumption of the terminal.

S590: The terminal device communicates with the network device by using the second beam based on the first duration.

For a communication process, refer to a conventional technology. Details are not described herein again.

According to the technical solution in this application, the first information is sent to the terminal device, so that the terminal device can determine, based on the first information, the duration from the moment at which the first beam stops the service to the moment from which the second beam provides the service, and communicate with the network device by using the second beam on the satellite. This helps provide a larger-range communication service, reduce the complexity of the terminal device, and improve user experience.

It should be understood that an “indication” in embodiments of this application may be an explicit indication and/or an implicit indication. For example, the implicit indication may be based on a position and/or a resource for transmission; and the explicit indication may be based on one or more parameters, one or more indexes, and/or one or more bit patterns that a beam represents. In addition, the “indication” may further represent “including”. For example, that the first timer indicates the duration from the moment at which the first beam stops the service to the moment from which the second beam provides the service may alternatively be expressed as that the first timer includes the duration from the moment at which the first beam stops the service to the moment from which the second beam provides the service.

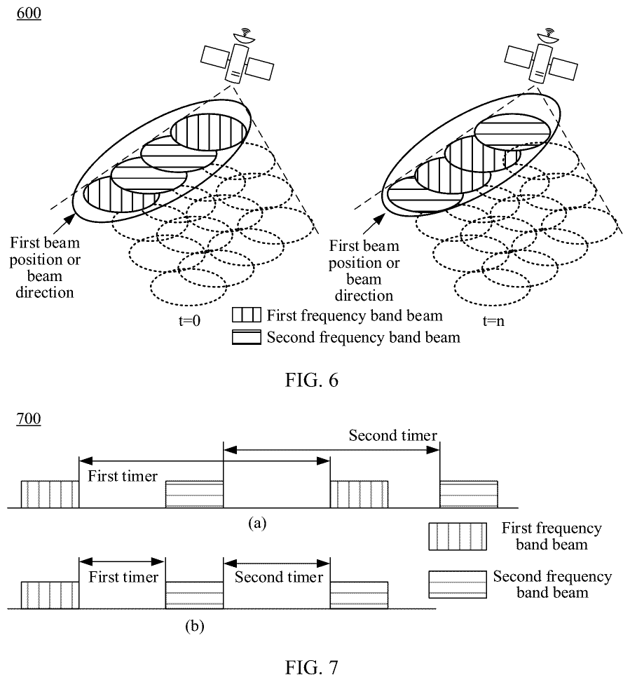

FIG. 6 is a schematic diagram of being served by beams in different frequency bands at different moments in a same beam position or beam direction according to this application.

The technical solutions in this application may be applicable to a scenario of being served by the beams in the different frequency bands at the different moments in the same beam position. In this scenario, one or more timers may need to be configured in one beam position or beam direction, and each beam has a corresponding timer and a corresponding bandwidth configuration. Starting and ending of the timer corresponding to the beam trigger the corresponding bandwidth configuration.

As shown in FIG. 6, the same beam position or beam direction is covered by different beams at a moment t=0 and a moment t=1. These beams correspond to different frequency bands, that is, correspond to different bandwidth configurations. A bandwidth configuration of a next beam may be sent on a previous beam, where the bandwidth configuration may also be referred to as a bandwidth resource.

In a possible implementation, a plurality of timers may be set to indicate service duration of the different beams. As shown in (a) in FIG. 7, beams in two different frequency bands are independent of each other. A first timer may indicate duration from a moment at which the 1^{st} first frequency band beam stops a service to a moment from which the 2^{nd} first frequency band beam provides a service. That is, when the 1^{st} first frequency band beam stops the service, the first timer is triggered to start. When the first timer ends, switching to a first frequency band beam in a next periodicity, namely, the 2^{nd} first frequency band beam, is performed. In this case, a first beam may be the 1^{st} first frequency band beam, a second beam may be the 2^{nd} first frequency band beam, and the first beam and the second beam are beams in a same frequency band.

Similarly, a second timer may indicate duration from a moment at which the 1^{st} second frequency band beam stops a service to a moment from which the 2^{nd} second frequency band beam provides a service. That is, when the 1^{st} second frequency band beam stops the service, the second timer is triggered to start. When the second timer ends, switching to a second frequency band beam in the next periodicity, namely, the 2^{nd} second frequency band beam, is performed. For ease of differentiation, in this case, the 1^{st} second frequency band beam may be referred to as a third beam, the 2^{nd} second frequency band beam may be referred to as a fourth beam, and the third beam and the fourth beam are beams in a same frequency band.

In another possible implementation, one timer may be set to indicate service duration of different beams. As shown in (b) in FIG. 7, beams in two different frequency bands share one timer. A first timer may indicate duration from a moment at which the 1^{st} first frequency band beam stops a service to a moment from which the 1^{st} second frequency band beam provides a service. That is, when the 1^{st} first frequency band beam stops the service, the first timer is triggered to start. When the first timer ends, switching to a second frequency band beam in a current periodicity, namely, the 1^{st} second frequency band beam, is performed. In this case, a first beam may be the 1^{st} first frequency band beam, a second beam may be the 1^{st} second frequency band beam, and the first beam and the second beam are beams in the different frequency bands.

Similarly, in a next periodicity, a second timer may indicate duration from a moment at which the 1^{st} second frequency band beam stops the service to a moment from which the 1^{st} first frequency band beam provides the service. That is, when the 1^{st} second frequency band beam stops the service, the second timer is triggered to start. When the second timer ends, switching to a first frequency band beam in the next periodicity, namely, the 2^{nd} first frequency band beam, is performed. For ease of differentiation, in this case, the 1^{st} second frequency band beam may still be referred to as the second beam, the 2^{nd} first frequency band beam may be referred to as a third beam, and the second beam and the third beam are beams in the different frequency bands.

In this way, according to the technical solution in this application, first information is sent to a terminal device, so that the terminal device can determine, based on the first information, the duration from the moment at which the first beam stops the service to the moment from which the second beam provides the service, and communicate with a network device by using the second beam on a satellite. This helps provide a larger-range communication service, reduce complexity of the terminal device, and improve user experience.

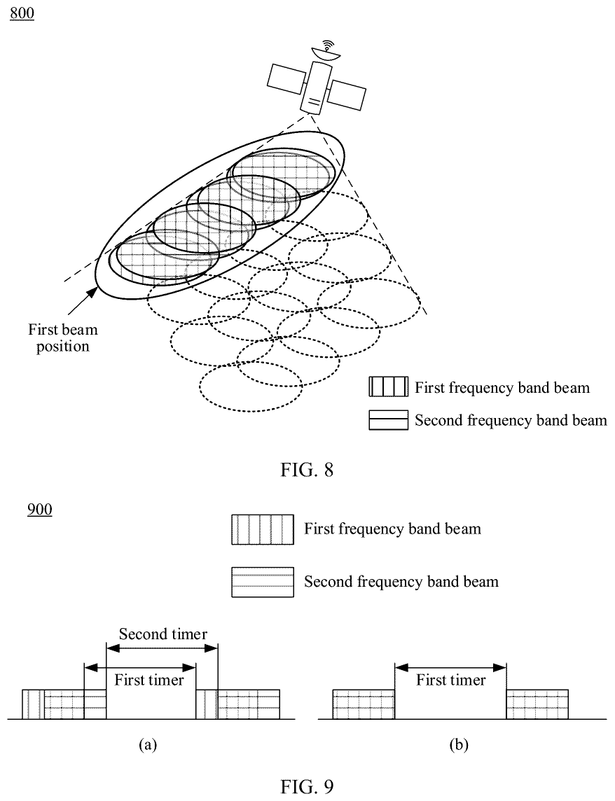

FIG. 8 is a schematic diagram of being served by beams in different frequency bands at a same moment in a same beam position or beam direction according to this application.

The technical solutions in this application may be applicable to a scenario of being served by the beams in the different frequency bands at the same moment in the same beam position or beam direction. In this scenario, one or more timers may need to be configured in one beam position or beam direction, and each beam has a corresponding timer and a corresponding bandwidth configuration. Starting and ending of the timer corresponding to the beam trigger the corresponding bandwidth configuration.

As shown in FIG. 8, the same beam position or beam direction is covered by different beams at the same moment. These beams correspond to different frequency bands, that is, correspond to different bandwidth configurations. A bandwidth configuration of a next beam may be sent on a previous beam, where the bandwidth configuration may also be referred to as a bandwidth resource.

When two beams overlap each other in one beam position or beam direction, each beam corresponds to a different bandwidth configuration, and a first frequency band beam and a second frequency band beam are used as an example, a terminal device may start a multi-connectivity transmission manner or a carrier aggregation manner, to implement throughput enhancement or coverage enhancement; or some terminal devices in the beam position or the beam direction access the first frequency band beam, and the other terminal devices access the second frequency band beam. In this case, when a broadcast beam sweeps a current area, resources of the two beams may be configured, and the terminal randomly selects one resource for access.

Optionally, the terminal device may first access one of the beams, and then the beam allocates a resource of the other beam.

Optionally, the different beams may be accessed based on a geographical location area of the terminal device in the beam position or the beam direction.

Optionally, the terminal device may be further indicated, based on an implicit indication manner, to access a corresponding beam. For example, the terminal device accesses the corresponding beam based on a random access parameter including parameters of a random access sequence and a random access resource.

When duration for which the first frequency band beam provides a service and duration for which the second frequency band beam provides a service are consistent, as shown in (a) in FIG. 9, a timer may be configured, may be referred to as a first timer, and indicates duration from a moment at which a first beam ends a service to a moment from which a second beam provides a service.

In a possible implementation, the terminal device may use only the first frequency band beam or the second frequency band beam. For example, the terminal device uses the 1^{st} first frequency band beam in a first periodicity, and uses the 2^{nd} first frequency band beam in a next periodicity. That is, in this case, the first timer indicates duration from a moment at which the 1^{st} first frequency band beam ends a service to a moment from which the 2^{nd} first frequency band beam provides a service. For another example, the terminal device uses the 1^{st} second frequency band beam in a first periodicity, and uses the 2^{nd} second frequency band beam in a next periodicity. That is, in this case, alternatively, the first timer indicates duration from a moment at which the 1^{st} second frequency band beam ends a service to a moment from which the 2^{nd} second frequency band beam provides a service.

In another possible implementation, the terminal device may alternately use the first frequency band beam and the second frequency band beam. For example, the terminal device uses the first frequency band beam in a first periodicity, and uses the second frequency band beam in a next periodicity. That is, in this case, the first timer indicates duration from a moment at which the first frequency band beam ends a service to a moment from which the second frequency band beam provides a service. For another example, the terminal device uses the second frequency band beam in a first periodicity, and uses the first frequency band beam in a next periodicity. That is, in this case, the first timer indicates duration from a moment at which the second frequency band beam ends a service to a moment from which the first frequency band beam provides a service.

When duration for which the first frequency band beam provides a service and duration for which the second frequency band beam provides a service are inconsistent, as shown in (b) in FIG. 9, two timers may be configured, and may be referred to as a first timer and a second timer. Both the first timer and the second timer may indicate duration from a moment at which a first beam ends a service to a moment from which a second beam provides a service.

Specifically, the terminal device may use the 1^{st} first frequency band beam in a first periodicity, and use the 2^{nd} first frequency band beam in a next periodicity. That is, in this case, the first timer indicates duration from a moment at which the 1^{st} first frequency band beam ends a service to a moment from which the 2^{nd} first frequency band beam provides a service. The terminal device may use the 1^{st} second frequency band beam in the first periodicity, and use the 2^{nd} second frequency band beam in the next periodicity. That is, in this case, alternatively, the second timer indicates duration from a moment at which the 1^{st} second frequency band beam ends a service to a moment from which the 2^{nd} second frequency band beam provides a service.

In addition, in embodiments of this application, one beam position or beam direction may be covered by a plurality of beams at a same moment, and these beams correspond to a same frequency band. For a terminal device, only a stronger signal is received. For an implementation thereof, refer to the foregoing descriptions. Details are not described herein again.

It should be understood that, in the foregoing solution, an example in which a plurality of beams on one satellite provide services for the terminal device is used to describe the technical solutions in this application. However, this should not be construed as a limitation on this application. When a plurality of beams on a plurality of satellites provide services for the terminal device, the technical solutions in this application are also applicable.

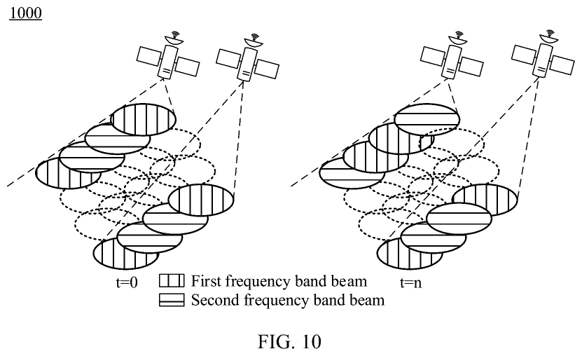

For example, in a scenario shown in FIG. 10, no matter at a moment t=0 or a moment t=1, a plurality of beams on two satellites provide services in some beam positions or beam directions. In this case, a first beam and a second beam may be beams on different satellites. In this case, ephemeris information of the first beam indicates ephemeris information corresponding to a case in which the first beam provides a service for a terminal device, and the ephemeris information further includes a related parameter of the satellite to which the first beam belongs. Similarly, ephemeris information of the second beam indicates ephemeris information corresponding to a case in which the second beam provides a service for the terminal device, and the ephemeris information further includes a related parameter of the satellite to which the second beam belongs. When the first beam and the second beam are the beams on the different satellites, during communication on the first beam, related parameter information of the satellite corresponding to the second beam when the second beam is used for communication needs to be sent to the terminal device. The related parameter information of the satellite corresponding to the second beam may include parameters related to synchronization and timing, and may further include a resource configuration status of the second beam.

Optionally, a network device may deliver one or more timers based on different statuses of the first beam and the second beam, to maintain communication on the plurality of beams on the different satellites. For this process, refer to the foregoing technical solution. Details are not described herein again.

It should be understood that the foregoing describes the technical solutions in this application by using an example in which the first timer indicates the duration from the moment at which the first beam stops the service to the moment from which the second beam provides the service. Based on this application, that a timer is for determining an interval between two beams to implement beam hopping communication of the terminal device shall not go beyond the protection scope of this application.

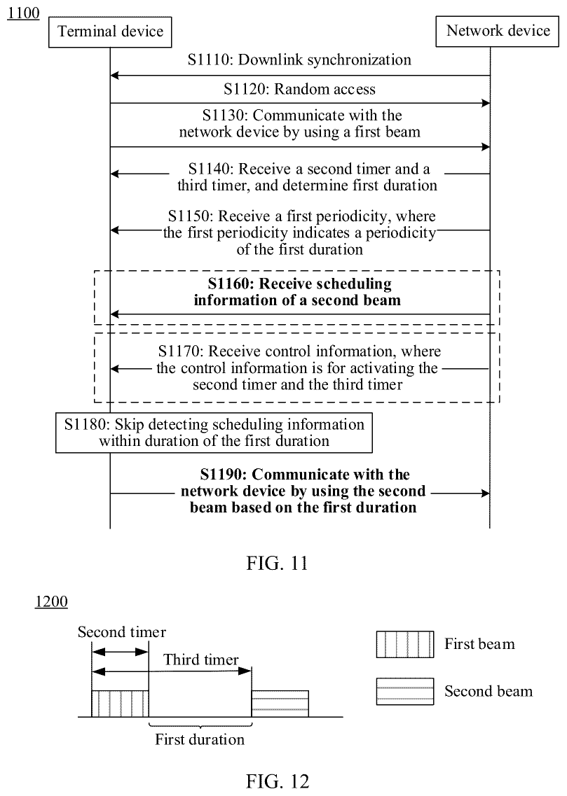

FIG. 11 is another schematic diagram of a specific example of a satellite communication method according to this application.

S1110 to S1130 are the same as S510 to S530 in FIG. 5. Details are not described herein again.

S1140: A terminal device receives a second timer and a third timer, and determines first duration.

The second timer and the third timer are carried in first information, the second timer indicates duration for which a first beam provides a service, and the third timer indicates duration of a periodicity of the first beam. The first duration indicates duration from a moment at which the first beam stops the service to a moment from which a second beam provides a service. A schematic diagram of the first beam and the second beam may be shown in FIG. 12. The second beam is the 1^{st} beam after the first beam. That is, the duration from the moment at which the first beam stops the service to the moment from which the second beam provides the service, namely, the first duration, is obtained by subtracting duration of the second timer from duration of the third timer.

The first beam and the second beam may be beams in a same frequency band, or may be beams in different frequency bands. For various cases thereof, refer to the foregoing descriptions. Details are not described herein again.

It should be understood that, the sequence numbers do not mean execution sequences. The execution sequences of the processes should be determined based on functions and internal logic of the processes, and should not be construed as any limitation on the implementation processes of embodiments of this application. For example, when the first information carrying the second timer and the third timer is a broadcast message, S1140 may be after S1110 and before S1120. For another example, when the first information carrying the second timer and the third timer is a UE-level message, S1140 may be after S1120. This is not limited in this application.

S1150: The terminal device receives a first periodicity, where the first periodicity indicates a periodicity of the first duration.

The first periodicity may directly indicate the periodicity of the first duration, or may indicate periodicities of the second timer and the third timer to indirectly indicate the periodicity of the first duration. This is not limited in this application.

Optionally, the first periodicity may be an agreed periodicity, or may be a periodicity determined in another manner, for example, implicit indication or index correspondence. For details, refer to the foregoing descriptions. Details are not described herein again.

S1160 is the same as S560 in FIG. 5. For brevity, details are not described herein again.

Scheduling information of the second beam may be received when the terminal uses the first beam for communication, or may be received before the second beam arrives. This is not limited in this application.

S1170: The terminal device receives control information, where the control information is for activating the second timer and the third timer.

The second timer and the third timer may be a configured fixed value, for example, 10 ms. However, in another possible implementation, during actual use, to improve configuration flexibility, a plurality of candidate values may be configured for the second timer and/or the third timer, and one of the candidate values is activated by using the control information. By way of example but not limitation, a candidate value set (2 ms, 4 ms, 8 ms, and 16 ms) is configured for the second timer, and the candidate value 4 ms is activated by using the control information. That is, it indicates that the second timer is activated, and duration of the second timer is 4 ms.

Optionally, when the terminal device activates the second timer and the third timer based on the control information, the second timer and the third timer may be activated (that is, immediately activated) in a slot in which the control information is received, or may be activated (that is, activated with a delay) in a period of time after the control information is received, where the period of time may be several milliseconds, several slots, or another time unit. This is not limited in this application.

S1180: The terminal device skips detecting scheduling information within timer of the first duration.

Specifically, within the timer of the first duration, the terminal device is covered by no broadcast beam or traffic beam (that is, served by no beam), and the terminal device does not need to monitor any signal. Therefore, some power-saving modes such as DRX may be used.

In this way, according to the technical solution in this application, the first information is sent to the terminal device, so that the terminal device can determine, based on the first information, the duration from the moment at which the first beam stops the service to the moment from which the second beam provides the service. In this way, the terminal device can skip detecting the scheduling information within the timer of the duration, thereby entering the power saving mode. This helps reduce complexity and power consumption of the terminal.

S1190 is the same as S590 in FIG. 5. Details are not described herein again.

According to the technical solution in this application, the first information is sent to the terminal device, so that the terminal device can determine, based on the first information, the duration from the moment at which the first beam stops the service to the moment from which the second beam provides the service, and communicate with a network device by using the second beam on a satellite. This helps provide a larger-range communication service, reduce the complexity of the terminal device, and improve user experience.

It should be understood that, in this embodiment of this application, when duration is indicated by a timer, timing of the duration may start at a moment at which the timer starts. However, during actual application, in a more possible implementation, timing of the duration starts at an offset parameter after the timer starts. For example, the second timer indicates the duration for which the first beam provides the service. The duration may be completely consistent with the duration of the second timer, or may be different from the duration of the second timer. That is, timing of the duration for which the first beam provides the service starts only after several time units after the second timer starts. The time unit may be a subframe, a slot, a symbol, or the like.

The satellite communication methods provided in embodiments of this application are described above in detail with reference to FIG. 4 to FIG. 12. The foregoing satellite communication methods are mainly described from a perspective of interaction between apparatuses. It may be understood that, to implement the foregoing functions, each apparatus includes a corresponding hardware structure and/or software module for performing each function. A person skilled in the art should be able to be aware that, in combination with the examples described in embodiments disclosed in this specification, units and algorithm steps can be implemented by hardware or a combination of hardware and computer software in this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

It should be understood that, the sequence numbers of the foregoing processes do not mean execution sequences. The execution sequences of the processes should be determined based on functions and internal logic of the processes, and should not be construed as any limitation on the implementation processes of embodiments of this application.

It should be further understood that, in embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

It may be understood that, in the foregoing embodiments of this application, a method implemented by a communication device may alternatively be implemented by a component (for example, a chip or a circuit) that may be configured inside the communication device.

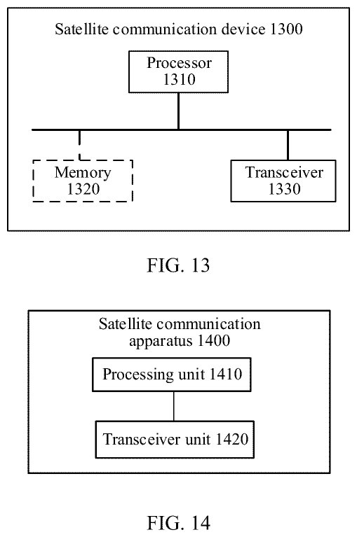

Satellite communication apparatuses provided in embodiments of this application are described below in detail with reference to FIG. 13 and FIG. 14. It should be understood that descriptions of apparatus embodiments correspond to the descriptions of the method embodiments. Therefore, for content that is not described in detail, refer to the foregoing method embodiments. For brevity, some content is not described again.

In embodiments of this application, a transmitting end device or a receiving end device division may be divided into function modules based on the foregoing method examples. For example, each function module may be obtained through division corresponding to each function, or two or more functions may be integrated in one processing module. The integrated module may be implemented in a form of hardware, or may be implemented in a form of a software function module. It should be noted that, in embodiments of this application, division into the modules is an example, and is merely logical function division. Another division manner may be used during actual implementation. An example in which each function module is obtained through division corresponding to each function is used below for description.

FIG. 13 is a schematic block diagram of a satellite communication device 1300 according to this application. Any device, for example, the terminal device and the network device, in any one of the method 400, the method 500, and the method 1100 may be implemented by the satellite communication device shown in FIG. 13.

It should be understood that the satellite communication device 1300 may be a physical device, a component (for example, an integrated circuit or a chip) in the physical device, or a function module in the physical device.

As shown in FIG. 13, the satellite communication device 1300 includes one or more processors 1310. Optionally, the processor 1310 may invoke an interface to implement receiving and sending functions. The interface may be a logical interface or a physical interface. This is not limited. For example, the interface may be a transceiver circuit, an input/output interface, or an interface circuit. The transceiver circuit, the input/output interface, or the interface circuit that is configured to implement the receiving and sending functions may be separated, or may be integrated together. The transceiver circuit or the interface circuit may be configured to read and write code/data, or the transceiver circuit or the interface circuit may be configured to perform signal transmission or transfer.

Optionally, the interface may be implemented by using a transceiver. Optionally, the satellite communication device 1300 may further include a transceiver 1330. The transceiver 1330 may also be referred to as a transceiver unit, a transceiver circuit, or the like, and is configured to implement the receiving and sending functions.

Optionally, the satellite communication device 1300 may further include a memory 1320. A specific deployment location of the memory 1320 is not specifically limited in this embodiment of this application. The memory may be integrated into the processor, or may be independent of the processor. When the satellite communication device 1300 does not include a memory, the satellite communication device 1300 only needs to have a processing function, and the memory may be deployed in another position (for example, a cloud system).

The processor 1310, the memory 1320, and the transceiver 1330 communicate with each other through an internal connection path, to transfer a control signal and/or a data signal.

It may be understood that, although not shown, the satellite communication device 1300 may further include another apparatus, for example, an input apparatus, an output apparatus, or a battery.

Optionally, in some embodiments, the memory 1320 may store execution instructions for performing the methods in embodiments of this application. The processor 1310 may execute the instructions stored in the memory 1320, and complete, in combination with other hardware (for example, the transceiver 1330), steps performed in the following method. For a specific working process and beneficial effects, refer to the descriptions in the foregoing method embodiments.

The methods disclosed in embodiments of this application may be applied to the processor 1310, or may be implemented by the processor 1310. The processor 1310 may be an integrated circuit chip, and has a signal processing capability. In an implementation process, the steps in the method may be completed through a hardware integrated logic circuit in the processor or by using instructions in a form of software. The foregoing processor may be a general purpose processor, a digital signal processor (DSP), an application specific integrated circuit (ASIC), a field programmable gate array (FPGA) or another programmable logic device, a discrete gate or a transistor logic device, or a discrete hardware component. The processor may implement or perform the methods, the steps, and the logical block diagrams that are disclosed in embodiments of this application. The general-purpose processor may be a microprocessor, or the processor may be any conventional processor or the like. The steps in the methods disclosed with reference to embodiments of this application may be directly performed and completed by a hardware decoding processor, or may be performed and completed by using a combination of hardware in a decoding processor and a software module. The software module may be located in a mature storage medium in the art, such as a random access memory (RAM), a flash memory, a read-only memory (ROM), a programmable read-only memory, an electrically erasable programmable memory, or a register. The storage medium is located in the memory. The processor reads the instructions in the memory, and completes the steps in the foregoing methods in combination with hardware of the processor.

It may be understood that the memory 1320 may be a volatile memory or a nonvolatile memory, or may include both a volatile memory and a nonvolatile memory. The non-volatile memory may be a read-only memory ROM, a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory RAM, and serves as an external cache. By way of example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM). It should be noted that the memory in the system and the methods in this specification aims to include, but not limited to, these and any memory of another appropriate type.

FIG. 14 is a schematic block diagram of a satellite communication apparatus 1400 according to this application.

Optionally, a specific form of the satellite communication apparatus 1400 may be a general-purpose computer device or a chip in the general-purpose computer device. This is not limited in this embodiment of this application. As shown in FIG. 14, the satellite communication apparatus includes a processing unit 1410 and a transceiver unit 1420.

Specifically, the satellite communication apparatus 1400 may be any device in this application, and may implement a function that can be implemented by the device. It should be understood that the satellite communication apparatus 1400 may be a physical device, a component (for example, an integrated circuit or a chip) in the physical device, or a function module in the physical device.

In a possible design, the satellite communication apparatus 1400 may be the terminal device in the foregoing method embodiments, or may be a chip configured to implement a function of the terminal device in the foregoing method embodiments.

In an example, the communication apparatus is configured to perform an action performed by the terminal device in FIG. 5 or FIG. 11.

The transceiver unit 1420 is configured to receive first information, where the first information is for determining first duration, the first duration indicates duration from a moment at which a first beam stops a service to a moment from which a second beam provides a service, and the first beam and the second beam are beams on satellites. The processing unit 1410 is configured to communicate with a network device by using the second beam based on the first duration.

In another possible design, the satellite communication apparatus 1400 may be the network device in the foregoing method embodiments, or may be a chip configured to implement a function of the network device in the foregoing method embodiments.

In an example, the communication apparatus is configured to perform an action performed by the network device in FIG. 5.

For example, the processing unit 1410 is configured to determine first information, where the first information is used by a terminal device to determine first duration, the first duration indicates duration from a moment at which a first beam stops a service to a moment from which a second beam provides a service, and the first beam and the second beam are beams on satellites. The transceiver unit 1420 is configured to send the first information to the terminal device.

It should be further understood that when the satellite communication apparatus 1400 is the network device, the transceiver unit 1420 in the satellite communication apparatus 1400 may be implemented by using a communication interface (for example, a transceiver or an input/output interface). The processing unit 1410 in the satellite communication apparatus 1400 may be implemented by using at least one processor, for example, may correspond to the processor 1310 shown in FIG. 13.

Optionally, the satellite communication apparatus 1400 may further include a storage unit. The storage unit may be configured to store instructions or data. The processing unit may invoke the instructions or the data stored in the storage unit, to implement a corresponding operation.

It should be understood that a specific process in which the units perform the foregoing corresponding steps has been described in detail in the foregoing method embodiments. For brevity, details are not described herein again.

In addition, in this application, the satellite communication apparatus 1400 is presented in a form of a function module. The “module” herein may be an application specific integrated circuit ASIC, a circuit, a processor that executes one or more software or firmware programs and a memory, an integrated logic circuit, and/or another component that may provide the foregoing functions. In a simple embodiment, a person skilled in the art may figure out that the apparatus 1400 may be in the form shown in FIG. 13. The processing unit 1410 may be implemented by using the processor 1310 shown in FIG. 13. Optionally, if the computer device shown in FIG. 13 includes the memory 1320, the processing unit 1410 may be implemented by using the processor 1310 and the memory 1320. The transceiver unit 1420 may be implemented by using the transceiver 1330 shown in FIG. 13. The transceiver 1330 includes the receiving function and the sending function. Specifically, the processor is implemented by executing a computer program stored in the memory. Optionally, when the apparatus 1400 is the chip, a function and/or an implementation process of the transceiver unit 1420 may alternatively be implemented by using a pin, a circuit, or the like. Optionally, the memory may be a storage unit in the chip, for example, a register or a cache. Alternatively, the storage unit may be a storage unit that is in the satellite communication apparatus and that is located outside the chip, for example, the memory 1320 shown in FIG. 13, or may be a storage unit that is deployed in another system or device and is not in the computer device.

Aspects or features of this application may be implemented as a method, an apparatus, or a product that uses standard programming and/or engineering technologies. For example, a computer-readable medium may include but is not limited to: a magnetic storage component (for example, a hard disk, a floppy disk, or a magnetic tape), an optical disc (for example, a compact disc (CD) or a digital versatile disc (DVD)), a smart card, and a flash memory component (for example, an erasable programmable read-only memory (EPROM), a card, a stick, or a key drive). In addition, various storage media described in this specification may indicate one or more devices and/or other machine-readable media that are configured to store information. The term “machine-readable media” may include but is not limited to various other media that can store, contain, and/or carry instructions and/or data.

According to the methods provided in embodiments of this application, this application further provides a computer program product. The computer program product includes a computer program or a group of instructions. When the computer program or the group of instructions are run on a computer, the computer is enabled to perform the method in any one of the embodiments shown in FIG. 4 to FIG. 12.

According to the methods provided in embodiments of this application, this application further provides a computer-readable storage medium. The computer-readable medium stores a program or a group of instructions. When the program or the group of instructions are run on a computer, the computer is enabled to perform the method in any one of the embodiments shown in FIG. 4 to FIG. 12.

According to the methods provided in embodiments of this application, this application further provides a communication system. The communication system includes the foregoing apparatus or device.

Terms such as “component”, “module”, and “system” used in this specification indicate computer-related entities, hardware, firmware, combinations of hardware and software, software, or software being executed. For example, a component may be, but is not limited to, a process that runs on a processor, the processor, an object, an executable file, an execution thread, a program, and/or a computer. As illustrated by using figures, both a computing device and an application that runs on the computing device may be components. One or more components may reside within a process and/or a thread of execution, and a component may be located on one computer and/or distributed between two or more computers. In addition, these components may be executed from various computer-readable media that store various data structures. The components may communicate by using a local and/or remote process based on a signal having one or more data packets (for example, data from two components interacting with another component in a local system, in a distributed system, and/or across a network such as the Internet interacting with another system by using the signal).

It should be further understood that the term “and/or” in this specification describes only an association relationship between associated objects and represents that three relationships may exist. For example, A and/or B may represent the following three cases: Only A exists, both A and B exist, and only B exists. In addition, the character “/” in this specification generally indicates an “or” relationship between the associated objects.

It should be further understood that numbers “first”, “second”, and the like are introduced in embodiments of this application only to distinguish between different objects, for example, distinguish between different “information”, “devices”, or “units”. Understanding of a specific object and a correspondence between different objects should be determined based on functions and internal logic thereof, and should not constitute any limitation on an implementation process of embodiments of this application.

It may be clearly understood by a person skilled in the art that, for the purpose of convenient and brief description, for a detailed working process of the foregoing systems, apparatuses, and units, refer to a corresponding process in the foregoing method embodiments. Details are not described herein again.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A satellite communication method, comprising:
receiving, by a terminal device, first information, wherein the first information comprises information associated with first duration, the first duration indicates duration from a moment at which a first beam stops a service to a moment from which a second beam provides a service, and the first beam and the second beam are beams on satellites; and
communicating, by the terminal device, with a network device by using the second beam based on the first duration.

2. The method according to claim 1, wherein the first information comprises a first timer, and the first timer indicates the first duration.

3. The method according to claim 1, wherein the first information comprises a second timer and a third timer, the second timer indicates duration for which the first beam provides the service, the third timer indicates duration of a periodicity of the first beam, and the method further comprises:
determining, by the terminal device, the first duration based on the duration for which the first beam provides the service and the duration of the periodicity of the first beam.

4. The method according to claim 1, wherein the method further comprises:
skipping, by the terminal device, detecting scheduling information from the network device within duration of a first timer.

5. The method according to claim 1, wherein the network device is located on a satellite, and the method further comprises:
receiving, by the terminal device, global navigation satellite system (GNSS) positioning information and ephemeris information of the second beam, wherein the ephemeris information of the second beam indicates ephemeris information corresponding to a case in which the second beam provides the service for the terminal device; and
synchronizing, by the terminal device, with the network device based on the GNSS positioning information and the ephemeris information.

6. The method according to claim 1, wherein the network device is located on a terrene, and the method further comprises:
receiving, by the terminal device, global navigation satellite system (GNSS) positioning information, ephemeris information of the second beam, and common timing advance information, wherein the ephemeris information of the second beam indicates ephemeris information corresponding to a case in which the second beam provides the service for the terminal device; and
synchronizing, by the terminal device, with the network device based on the GNSS positioning information, the ephemeris information, and the common timing advance information.

7. The method according to claim 1, wherein the method further comprises:
receiving, by the terminal device, scheduling information corresponding to the second beam.

8. The method according to claim 1, wherein the first beam corresponds to a first bandwidth configuration, the second beam corresponds to a second bandwidth configuration, and the first bandwidth configuration is the same as the second bandwidth configuration.

9. The method according to claim 1, wherein the first beam corresponds to a first bandwidth configuration, the second beam corresponds to a second bandwidth configuration, and the first bandwidth configuration is different from the second bandwidth configuration.

10. The method according to claim 1, wherein the method further comprises:
obtaining, by the terminal device, a first periodicity, wherein the first periodicity indicates a periodicity of the first duration; and
the communicating, by the terminal device, with a network device by using the second beam based on the first duration comprises:
communicating, by the terminal device, with the network device by using the second beam based on the first duration and the first periodicity.

11. The method according to claim 1, wherein the method further comprises:
receiving, by the terminal device, control information; and
activating, by the terminal device, a first timer based on the control information; or
activating, by the terminal device, a second timer and a third timer based on the control information.

12. A satellite communication method, comprising:
determining, by a network device, first information, wherein the first information comprises information associated with first duration, the first duration indicates duration from a moment at which a first beam stops a service to a moment from which a second beam provides a service, and the first beam and the second beam are beams on satellites; and
sending, by the network device, the first information to a terminal device.

13. The method according to claim 12, wherein the first information comprises a first timer, and the first timer indicates the first duration.

14. The method according to claim 12, wherein the first information comprises a second timer and a third timer, the second timer indicates duration for which the first beam provides the service, and the third timer indicates duration of a periodicity of the first beam.

15. The method according to claim 12, wherein the method further comprises:
skipping, by the network device, sending scheduling information to the terminal device within timer of the first duration.

16. The method according to claim 12, wherein the network device is located on a satellite, and the method further comprises:
sending, by the network device, global navigation satellite system (GNSS) positioning information and ephemeris information of the second beam, wherein the ephemeris information of the second beam indicates ephemeris information corresponding to a case in which the second beam provides the service for the terminal device, and the GNSS positioning information and the ephemeris information are used by the terminal device to synchronize with the network device.

17. The method according to claim 12, wherein the network device is located on a terrene, and the method further comprises:
sending, by the network device, global navigation satellite system (GNSS) positioning information, ephemeris information of the second beam, and common timing advance information, wherein the ephemeris information of the second beam indicates ephemeris information corresponding to a case in which the second beam provides the service for the terminal device, and the GNSS positioning information, the ephemeris information, and the common timing advance information are used by the terminal device to synchronize with the network device.

18. The method according to claim 12, wherein the method further comprises:
receiving, by the terminal device, scheduling information corresponding to the second beam.

19. The method according to claim 12, wherein the first beam corresponds to a first bandwidth configuration, the second beam corresponds to a second bandwidth configuration, and the first bandwidth configuration is the same as the second bandwidth configuration.

20. A communication apparatus, comprising:
at least one processor; and
one or more memories coupled to the at least one processor and storing programming instructions for execution by the at least one processor to cause the communication apparatus to perform operations comprising:
receiving, by a terminal device, first information, wherein the first information is for determining first duration, the first duration indicates duration from a moment at which a first beam stops a service to a moment from which a second beam provides a service, and the first beam and the second beam are beams on satellites; and
communicating, by the terminal device, with a network device by using the second beam based on the first duration.
